(19) United States
(12) Patent Application Publication
(10) Pub. No.: US 2015/0178047 A1
(43) Pub. Date: Jun. 25, 2015

(54) METHOD OF FAST ARCTANGENT CALCULATION PRE AND POST PROCESSING

(71) Applicant: GM GLOBAL TECHNOLOGY OPERATIONS LLC, Detroit, MI (US)

(72) Inventor: Ray M. Ransom, Big Bear City, CA (US)

(73) Assignee: GM GLOBAL TECHNOLOGY OPERATIONS LLC, Detroit, MI (US)

(21) Appl. No.: 14/140,026

(22) Filed: Dec. 24, 2013

(51) Int. Cl. G06F 7/548

(52) U.S. Cl. CPC G06F 7/548; G06F 2207/544

(57) ABSTRACT

A method of calculating an arctangent includes coding a sign for a y-value an x-value into a 3-bit index. When the absolute value of the x-value is greater than the absolute value of the y-value, the absolute values of the x-value and the y-value are swapped, and a swap bit of the index is coded to indicate that the x-value and the y-value were swapped. The arctangent is calculated from the quotient of the swapped x-value divided by the swapped y-value. A segment base angle is extracted from a table, based on the coded x-bit, y-bit, and swap bit of the index. An encoded sign is extracted from the segment base angle and is applied to the calculated arctangent output value to define a corrected arctangent value. The segment base angle is added to the corrected arctangent value to define the arctangent of the point.

### TECHNICAL FIELD

The invention generally relates to a method of calculating an arctangent, and more specifically to the pre-processing and post-processing of data for fast arctangent calculations.

### BACKGROUND

Vehicle controllers often need to calculate an arctangent during control of various vehicle systems. For example, a vehicle controller may need to calculate an arctangent in order to properly control an electric motor of a hybrid vehicle.

An arctangent may only be calculated over a 45° segment of a 360° degree circle. Accordingly, any x-value input and y-value input used to calculate an arctangent value must be adjusted from an initial octant (i.e., an initial 45° segment) to the segment of the circle corresponding to the 45° segment in which the arctangent may be calculated. After the numerical value of the arctangent is calculated, it must be adjusted back into the initial octant of the circle.

### SUMMARY

A method of calculating an arctangent for a point located on a plane by a y-value and an x-value of a Cartesian coordinate system is provided. The method includes coding a y-bit of an index to indicate a sign of the y-value, and coding an x-bit of the index to indicate a sign of the x-value. A sign bit of a binary value representing the y-value is removed to define a cleared y-value, and a sign bit of a binary value representing the x-value is removed to define a cleared x-value. When the cleared x-value is equal to or less than the cleared y-value, an arctangent calculation input argument is calculated by dividing the cleared x-value by the cleared y-value. The arctangent of the input argument is then calculated to define a calculated arctangent output value. When the cleared x-value is greater than the cleared y-value, the cleared x-value is swapped for the cleared y-value to define a swapped x-value, and the cleared y-value is swapped for the cleared x-value to define a swapped y-value. A swap bit of the index is coded to indicate that the cleared x-value and the cleared y-value were swapped to define the swapped x-value and the swapped y-value respectively. When the cleared x-value is greater than the cleared y-value, an arctangent calculation input argument is calculated by dividing the swapped x-value by the swapped y-value. The arctangent of the input argument is then calculated to define a calculated arctangent output value. A segment base angle is looked up from an angle adjustment table, based on the coded x-bit, the coded y-bit, and the coded swap bit of the index. A numerical sign is extracted from a reverse bit coded into the extracted segment base angle. The numerical sign of the reverse bit from the segment base angle is applied to the calculated arctangent output value to define a corrected arctangent value, and the reverse bit of the segment base angle is cleared to define a cleared segment base angle. The corrected arctangent value is added to the cleared segment base angle to define the arctangent of the point.

Accordingly, the three Boolean bits that are coded into the index, i.e., the y-bit, the x-bit, and the swap bit, are used to fetch an encoded value from a look-up table, i.e., the angle adjustment table, which is used to reverse and adjust the calculated numerical output from the arctangent calculation. This minimizes pre-processing and post-processing time associated with the arctangent calculation, thereby improving processing speed.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a graph showing the different octants of a circle on a Cartesian coordinate system.

FIG. 2 is a chart showing all possible values for a segment base angle and their respective 32-bit floating point binary storage format.

FIG. 3 is a chart representing an angle adjustment table for relating an index to each of the octants of the circle shown in FIG. 1.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the invention, as defined by the appended claims. Furthermore, the invention may be described herein in terms of functional and/or logical block components and/or various processing steps. It should be realized that such block components may be comprised of any number of hardware, software, and/or firmware components configured to perform the specified functions.

Referring to the Figures, wherein like numerals indicate like parts throughout the several views, a method of calculating an arctangent for a point is provided. The method may be performed by a controller, such as but not limited to a computer or control module. The controller is operable to perform the various processes necessary to calculate the arctangent in accordance with the method described below. The controller includes all software, hardware, memory, processor, algorithms, coding, etc. necessary to calculate the arctangent as described below.

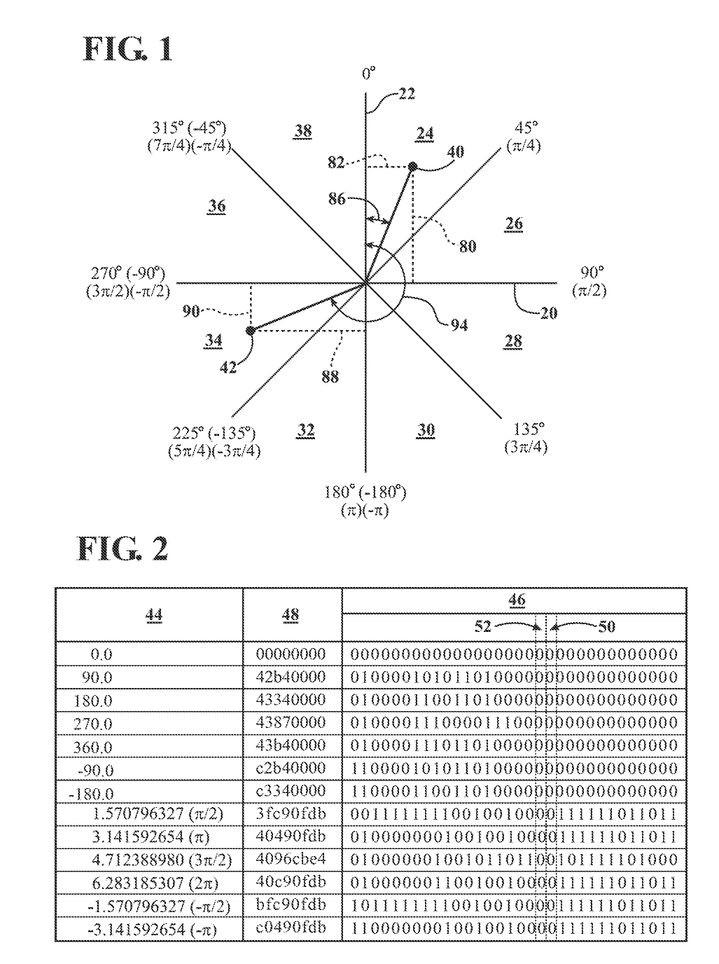

Referring to FIG. 1, the point for which the arctangent is calculated is located on a plane by a y-value and an x-value of a Cartesian coordinate system. Within FIG. 1, an x axis of the Cartesian coordinate system is shown at 20, and a y axis is shown at 22. The Cartesian coordinate system is divided into eight different octants. Each octant spans a 45° segment. A first octant is generally shown at 24, a second octant is generally shown at 26, a third octant is generally shown at 28, a fourth octant is generally shown at 30, a fifth octant is generally shown at 32, a sixth octant is generally shown at 34, a seventh octant is generally shown at 36, and an eighth octant is generally shown at 38. The angles of the coordinate system are shown increasing in a clockwise fashion, with a zero angle defined as the portion of the y-axis lying above the x axis as viewed on the page. The first octant spans between 0° and 45°. The second octant spans between 45° and 90°. The third octant spans between 90° and 135° degrees. The fourth octant spans between 135° and 180° (which may also be represented as) −180°. The fifth octant spans between 180° and 225° (which may also be represented as) −135°. The sixth octant spans between 225° and 270° (which may also be represented as) −90°. The seventh octant spans between 270° and 315° (which may also be represented as) −45°. The eighth octant spans between 315° and 0° (which may also be represented as 360°). Although the different octants are described in degrees, it should be appreciated that the different octants may alternatively be described in radians. Furthermore, the octants may also be described as signed or unsigned. Accordingly, the different octants can be described in four different manners: signed degrees, unsigned degrees, signed radians, or unsigned radians. FIG. 1 shows the different manners in which the angular position of the octants may be described.

A first point 40 is shown in the first octant. The arctangent of the first point 40 is calculated in Example 1 below. A second point 42 is shown in the sixth octant. The arctangent of the second point 42 is calculated in Example 2 below.

The method includes establishing an index in the memory of the controller. The index is a 3-bit binary value, which is used to save Boolean information of three different input parameters (the y-value, the x-value, and a swap bit). The index is later used to retrieve a value from a look-up table, which is used to reverse and/or adjust a calculated arctangent output value. Although the index only uses 3-bits to save the Boolean information of the input parameters, the index is encoded in the number of bits used by the controller, such as but not limited to a 32-bit, IEEE-754 standard floating point number format, shown and described herein. These three bits of the index include a y-bit, an x-bit, and the swap bit. For example, the index may be represented as syx00, wherein “s” represents the swap bit, “y” represents the y-bit, and “x” represents the x-bit. The x-bit, the y-bit, and the swap bit are pre-shifted for use as a table look-up index for a table containing 32-bit data. Preferably, and as represented above, the x-bit, the y-bit, and the swap bit are coded into a second bit, a third bit, and a fourth bit of the index, respectively.

As is known, a single precision floating point number is 32-bits in size. In most processors, the fundamental unit of memory is 8 bits (1 byte). In most processors, which use a 32-bit system, the 32-bit value takes up 4 bytes of memory, so in order to point to one contiguous group of a 32-bit number, the address must increment in steps of 4. Pre-shifting the index left by two bits multiplies it by 4. Since the bits are inserted into the index individually, the shift is free, i.e., does not require processing time. If the index were right justified, i.e., not pre-shifted, then the processor/controller would have to shift the index left by two bits before using the index to reference a look-up table. Accordingly, by pre-shifting the index, the speed of the look-up is increased.

In order to calculate the arctangent for any given point, the sign of the y-value is coded into the y-bit of the index, which is used to indicate the sign of the y-value. The sign is either a positive (+) sign or a negative (−) sign. As is generally appreciated, a positive sign is generally represented in binary code by a “0”, and a negative sign is generally represented in binary code by a “1”. Accordingly, if the y-value includes a negative sign, i.e., if the y-value is a negative number, the y-bit may be coded with a “1”, whereas if the y-value includes a positive number, i.e., if the y-value is a positive number, the y-bit may be coded with a “0”. The sign of the x-value is coded into the x-bit of the index, which is used to indicate the sign of the x-value. The sign is either a positive (+) sign or a negative (−) sign. Accordingly, if the x-value includes a negative sign, i.e., if the x-value is a negative number, the x-bit may be coded with a “1”, whereas if the x-value includes a positive number, i.e., if the x-value is a positive number, the x-bit may be coded with a “0”.

Once the signs of the y-value and the x-value of the point have been coded into the y-bit and the x-bit of the index, the signs are cleared or masked from the x-value and the y-value to define a cleared x-value and a cleared y-value respectively. The cleared x-value and the cleared y-value effectively define an absolute value of the x-value and the y-value respectively. The signs of the y-value and the x-value are cleared or masked using integer operations, instead of floating point operations. Integer operations include mathematical and logical operations that are performed on integers, as understood and appreciated by those skilled in the art. The x-value and the y-value may be saved in the memory of the controller in a 32-bit binary floating point form, and represented by a 32-bit floating point number. Accordingly, clearing or masking the sign from the x-value and the sign from the y-value to define the absolute value of the x-value and the absolute value of the y-value may include clearing a sign bit in the 32-bit floating point number of the x-value and the y-value respectively, to define the y-value and the x-value as a positive number. As is generally appreciated, the sign of a number represented by a 32-bit floating point number is indicated by the sign bit, which is the most significant, typically the leftmost bit of the 32-bit floating point number. As is generally appreciated, a positive sign is generally represented in binary code by a “0”, and a negative sign is generally represented in binary code by a “1”. As such, clearing the sign bit includes changing the sign bit to “0”.

After the sign of the y-value and the x-value are cleared to define the cleared x-value and the cleared y-value respectively, which effectively defines the absolute value of the x-value and the y-value respectively, the cleared x-value (the effective absolute value of the x-value) is compared to the cleared y-value (the effective absolute value of the y-value) to determine if the cleared x-value is greater than the cleared y-value, or if the cleared x-value is equal to or less than the cleared y-value. The cleared x-value is compared to the cleared y-value using integer operations, instead of floating point operations. Accordingly, the cleared x-value is compared to the cleared y-value using an integer compare, instead of a floating point compare. Because the arctangent of an angle is calculated from a quotient of an x-value divided by a y-value, the y-value, being the denominator, must include a non-zero number. Therefore, if the cleared y-value (the effective absolute value of the y-value) is equal to zero, a value equal to zero is returned as the calculated arctangent output value of the point. When the cleared x-value (the effective absolute value of the x-value) is equal to or less than the cleared y-value (the effective absolute value of the y-value), an arctangent calculation input argument is calculated by dividing the cleared x-value by the cleared y-value. The arctangent of the input argument is then calculated to define the calculated arctangent output value. As such, the arctangent of the quotient of the cleared x-value divided by the cleared y-value is calculated to define the calculated arctangent output value.

When the cleared x-value (the effective absolute value of the x-value) is greater than the cleared y-value (the effective absolute value of the y-value), then the cleared x-value is swapped for the cleared y-value to define a swapped x-value, and the cleared y-value is swapped for the cleared x-value to define a swapped y-value. Accordingly, the swapped x-value is equal to the cleared y-value (the effective absolute value of the y-value), and the swapped y-value is equal to the cleared x-value (the effective absolute value of the x-value). If the point falls within the second octant 26, the fourth octant 30, the sixth octant 34, or the eighth octant 38, then the cleared values of the x-value and the y-value are swapped.

When the cleared x-value and the cleared y-value are swapped, the swap bit of the index is coded to indicate that the cleared x-value and the cleared y-value were swapped to define the swapped x-value and the swapped y-value respectively. In the exemplary embodiment, the swap bit is coded with a “0” to indicate that the cleared x-value and the cleared y-value have not been swapped. In contrast, in the exemplary embodiment, the swap bit is coded with a “1” to indicate that the cleared x-value and the cleared y-value have been swapped. For example, if the point includes an x-value equal to −4, and a y-value equal to −3, then the cleared x-value (4) is greater than the cleared y-value (3), and the cleared values of the x-value and the y-value are swapped. As such, the swap bit is coded as “1”. Because both the x-value and the y-value include a negative sign, both the x-bit and the y-bit are coded as “1”. Accordingly, in the exemplary embodiment, the coded index for a point having an x-value equal to −4 and a y-value equal to −3 is represented in binary form in the pre-shifted index by 11100. When the cleared x-value is greater than the cleared y-value, and after the swap bit has been coded into the index, then an arctangent calculation input argument is calculated by dividing the swapped x-value by the swapped y-value. The arctangent of the input argument is then calculated to define the calculated arctangent output value. As such, the arctangent of the quotient of the swapped x-value divided by the swapped y-value is calculated to define the calculated arctangent output value.

In the preceding exemplary embodiment, the swap bit is encoded with a “1” to indicate that the cleared x-value and the cleared y-value have been swapped, and is encoded with a “0” to indicate that the cleared x-value and the cleared y-value have not been swapped. However, it should be appreciated that the polarity of the swap bit may be reversed, with the swap bit coded with a “0” to indicate that the cleared x-value and the cleared y-value have been swapped, and coded with a “1” to indicate that the cleared x-value and the cleared y-value have not been swapped. If the polarity of the swap bit is reversed from the exemplary embodiment described above, it should be appreciated that the various look-up tables described in detail below must be re-ordered appropriately.

The coded index, including the coded values for the x-bit, the y-bit, and the swap bit, is used to look-up a segment base angle from an angle adjustment table. Notably, by combining all information required for post-processing of the calculated arctangent output value into a single element of the angle adjustment table, only one access into a single look-up table (the angle adjustment table) is required to calculate the arctangent of the point, thereby reducing memory usage and increasing processing speed.

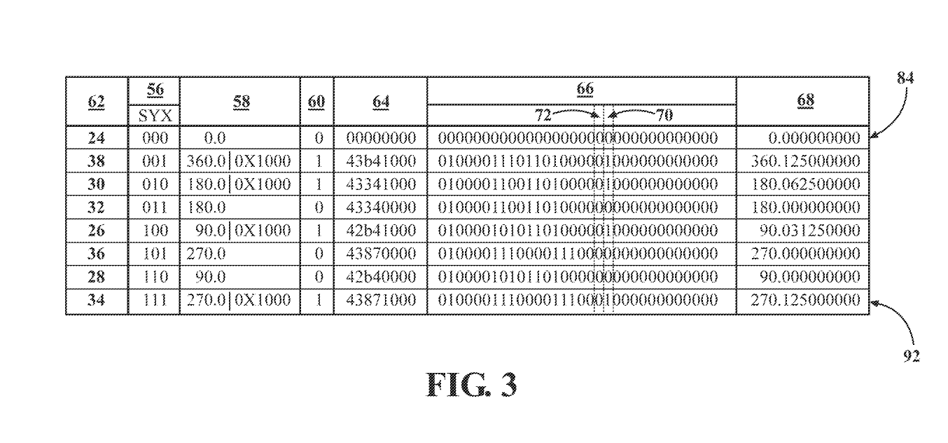

The segment base angle may be saved in the memory of the controller in a 32-bit binary floating point form, and represented by a 32-bit floating point number. Referring to FIG. 2, all possible values of the segment base angle that may be used in the angle adjustment table are provided in column 44, and the 32-bit floating point number for each segment base angle is provided in column 46. Column 48 of FIG. 3 shows a hexadecimal representation of the floating point number for each possible value of the segment base angle.

Preferably, the reverse bit is coded into one of bit 12 or bit 13 of the 32-bit floating point number representing the segment base angle. Bit 12 is shown in column 50 of FIG. 2, and bit 13 is shown in column 52 of FIG. 2. FIG. 2 shows that bit 12 and bit 13 are both zero for all possible values of the segment base angle. Accordingly, bit 12 or bit 13 is used to code the reverse bit into the 32-bit floating point number representing the segment base angle, because bits 12 and bit 13 are always otherwise zero for all possible values of the segment base angle.

The angle adjustment table of the exemplary embodiment is shown in FIG. 3. The angle adjustment table shown in FIG. 3 is configured for use with unsigned degrees. It should be appreciated that if the arctangent calculations are performed using some other angular unit, such as with signed degrees, unsigned radians, or signed radians, then the angle adjustment table would be configured differently to use the desired angular unit.

Within FIG. 3, column 56 lists all 8 possible combinations for the swap bit, the y-bit, and the x-bit, wherein s represents the swap bit, y represents the y-bit, and x represents the x-bit. The segment base angle for each possible coded combination of the index is provided in column 58. Each row of column 58 includes a floating point number, or a floating point number “OR”ed with an integer, which sets a reverse bit (described in greater detail below). An output angle adjustment sign value for each possible coded combination of the index is provided in column 60. The specific octant for each possible coded combination of the index is provided in column 62.

The segment base angle and encoded output angle adjustment sign value for each possible coded combination of the index are provided in column 64 in hexadecimal form. The segment base angle and encoded output angle adjustment sign value for each possible coded combination of the index are provided in column 66 in 32-bit binary floating point form. The segment base angle and encoded output angle adjustment sign value for each possible coded combination of the index are provided in column 68 in floating point decimal form.

Once the segment base angle is looked-up from the angle adjustment table based upon the specific coding of the index, a numerical sign for the calculated arctangent output value is extracted from a reverse bit encoded in the segment base angle. The numerical sign may include either a positive (+) sign for a positive number, or a negative (−) sign for a negative number. As is generally appreciated, a positive sign is generally coded into a 32-bit floating point number as a “0”, and a negative sign is generally coded into a 32-bit floating point number as a “1”. Accordingly, the reverse bit may be coded with a “0” for a positive sign, or with a “1” for a negative sign. As noted above, the reverse bit is coded into one of bit 12 or bit 13 of the 32-bit floating point number representing the segment base angle, because bit 12 and bit 13 all always otherwise zero for all values of the segment base angle. Bit 12 is shown in column 70 of FIG. 3, and bit 13 is shown in column 72 of FIG. 3. As shown in FIG. 3, bit 12 is used to code the reverse bit into the 32-bit floating point number representing the segment base angle.

The numerical sign extracted from the reverse bit is applied to the calculated arctangent output value, calculated above, to define a corrected arctangent value. Accordingly, the corrected arctangent value may include either a negative number or a positive number. The numerical sign is applied to the calculated arctangent output value using integer operations, instead of floating point operations. The reverse bit of the segment base angle is then masked or cleared to define a cleared segment base angle. The cleared segment base angle is the true or actual value of the segment base angle. Accordingly, the cleared segment base angle may include either a positive number or a negative number.

Clearing the reverse bit of the segment base angle to define the cleared segment base angle includes clearing the reverse bit in the 32-bit floating point number representing the segment base angle. The reverse bit is cleared using a basic integer “clearing” operation, as understood by those skilled in the art.

The corrected arctangent value is then added to the cleared segment base angle (i.e., the true or actual value of the segment base angle) to define the arctangent of the point. It should be appreciated that the corrected arctangent value may include either a positive or negative number, and that the cleared segment base angle may also include either a positive or negative number. Accordingly adding the corrected arctangent value to the cleared segment base angle may include adding a positive number to a positive number, a negative number to a positive number, or a negative number to a negative number.

The above described process removes all branches from the pre-processing and post-processing of the input data used to calculate the arctangent of the point. As is understood by those skilled in the art, a branch is an instruction in a computer program that may, when executed by the controller, cause the controller to begin execution of a different instruction sequence. Each time the linear flow of the processor is interrupted by a branch, the processor slows down. The above described method removes all branches from the pre-processing and post-processing of the input data, thereby increasing the speed required to calculate the arctangent of the point.

### Example 1

The process for calculating the arctangent for the first point 40 is herein described below. The first point 40 includes a y-value 80 that is equal to 4, and an x-value 82 that is equal to 3. Because both the y-value 80 and the x-value 82 are positive, both the y-bit and the x-bit of the index are coded with a “0”. The sign bits of the 32-bit floating point numbers representing the x-value and the y-value respectively are then masked or cleared to define the cleared x-value and the cleared y-value respectively. As noted above, the cleared x-value effectively defines the absolute value of the x-value, and the cleared y-value effectively defines the absolute value of the y-value. The cleared x-value is equal to 3, and the cleared y-value is equal to 4. Because the cleared x-value is less than the cleared y-value, the cleared x-value and the cleared y-value are not swapped, and the swap bit is coded into the index with a value of “0”. Accordingly, the swap bit is coded with a “0”, the y-bit is coded with a “0”, and the x-bit is coded with a “0”. Therefore, the shifted index may be represented by a binary value as 00000. The arctangent of the quotient of the cleared x-value divided by the cleared y-value is then calculated to define the calculated arctangent output value. More specifically, an arctangent calculation input argument is calculated by dividing the cleared x-value by the cleared y-value. The arctangent of the input argument, i.e., the quotient of the cleared x-value divided by the cleared y-value, is then calculated to define the calculated arctangent output value. Accordingly, the arctangent calculation input argument is equal to the quotient of 3 divided by 4. The calculated arctangent output value is equal to the arctangent if the input value, i.e., the arctangent of the quotient of 3 divided by 4, (arctan 3/4) which is equal to 36.87°. Referring to FIG. 3, the segment base angle for the coded index is retrieved from the angle adjustment table. The segment base angle for the index, having the swap bit defined as “0”, the y-bit defined as “0”, and the x-bit defined as “0’, is provided in row 84 of FIG. 3, and includes a value of 0°. The 32-bit floating point number for the segment base angle having a value of 0° is provided in column 66, row 84 of FIG. 3. Column 70 of FIG. 3 provides the reverse bit for the segment base angle, which includes a coding of “0”, indicating a positive sign. The reverse bit is then cleared to define the cleared segment base angle. As noted above, the cleared segment base angle defines the actual or true value of the segment base angle, which may include either a negative or a positive number. Since the reverse bit was already coded as “0”, indicating a positive sign, the reverse bit is not changed in this example, and the cleared segment base angle is equal to 0°. The reverse bit extracted from the segment base angle, (a positive sign in this example) is then applied to the calculated arctangent output value to define the corrected arctangent value. As noted above, the calculated arctangent output value is equal to 36.87°, and the reverse bit extracted from the segment base angle is positive, so the corrected arctangent value is equal to +36.87°. The corrected arctangent value (+36.87°) is then added to the cleared segment base angle (0°) to define the arctangent of the first point 40. Accordingly, the arctangent of the first point 40 is calculated as 36.87°, and is indicated by angle 86, shown in FIG. 1.

### Example 2

The process for calculating the arctangent for the second point 42 is herein described below. The second point 42 includes a x-value 88 that is equal to −4, and an y-value 90 that is equal to −3. Because both the x-value 88 and the y-value 90 are negative, both the x-bit and the y-bit of the index are coded with a “1”. The sign bits of the 32-bit floating point numbers representing the x-value 88 and the y-value 90 respectively are then cleared to define the cleared x-value and the cleared y-value respectively. As noted above, the cleared x-value and the cleared y-value effectively define the absolute value of the x-value and the y-value respectively. The cleared x-value is equal to 4, and the cleared y-value is equal to 3. Because the cleared x-value is greater than the cleared y-value (4>3), the cleared x-value and the cleared y-value are swapped to define the swapped x-value and the swapped y-value. As such, the swapped x-value is equal to the cleared y-value (swapped x-value=3), and the swapped y-value is equal to the cleared x-value (swapped y-value=4). Because the cleared x-value and the cleared y-value are swapped, the swap bit is coded into the index with a value of “1”. Accordingly, the swap bit is coded with a “1”, the y-bit is coded with a “1”, and the x-bit is coded with a “1”. Therefore, the shifted index may be represented by a binary value as 11100. The arctangent of the quotient of the swapped x-value divided by the swapped y-value is then calculated to define the calculated arctangent output value. More specifically, an arctangent calculation input argument is calculated by dividing the swapped x-value by the swapped y-value. The arctangent of the input argument, i.e., the quotient of the swapped x-value divided by the swapped y-value, is then calculated to define the calculated arctangent output value. Accordingly, the arctangent calculation input argument is equal to the quotient of 3 divided by 4. The calculated arctangent output value is equal to the arctangent of the input value, i.e., the arctangent of the quotient of 3 divided by 4, (arctan 3/4) which is equal to 36.87°. Referring to FIG. 3, the segment base angle for the coded index is retrieved from the angle adjustment table. The segment base angle for the index, having the swap bit defined as “1”, the y-bit defined as “1”, and the x-bit defined as “1’, is provided in row 92 of FIG. 3, and includes a value of “270.0|0x1000”, “0x43871000” in integer form, or “270.125” in floating point number form. The 32-bit floating point number for the segment base angle having a value of 0x43871000, which is equal to 270.125 is provided in column 66, row 92 of FIG. 3. Column 70 of FIG. 3 provides the reverse bit for the segment base angle, which includes a coding of “1”, indicating a negative sign. The reverse bit is then cleared to define the cleared segment base angle, which is the actual or true value of the segment base angle. Since the reverse bit was coded as “1”, indicating a negative sign, the reverse bit is cleared to define a value of “0”, thereby restoring the segment base angle to its true or actual value of 270°.

The negative sign indicated by the reverse bit, which was extracted from the segment base angle, is then applied to the calculated arctangent output value to define the corrected arctangent value. As noted above, the calculated arctangent output value is equal to 36.87°, and the reverse bit extracted from the segment base angle is negative, so the corrected arctangent value is equal to −36.87°. The corrected arctangent value (−) 36.87° is then added to the cleared segment base angle (270°) to define the arctangent of the second point 42. Accordingly, arctangent of the second point 42 is calculated as 233.13°, and is indicated by angle 94, shown in FIG. 1.

The detailed description and the drawings or figures are supportive and descriptive of the invention, but the scope of the invention is defined solely by the claims. While some of the best modes and other embodiments for carrying out the claimed invention have been described in detail, various alternative designs and embodiments exist for practicing the invention defined in the appended claims.

1. A method of calculating an arctangent for a point located on a plane by a y-value and an x-value of a Cartesian coordinate system, the method comprising:
coding a y-bit of an index, with a controller, to indicate a sign of the y-value;
coding an x-bit of the index, with the controller, to indicate a sign of the x-value;
clearing a sign bit of a binary value representing the y-value, with the controller, to define a cleared y-value;
clearing a sign bit of a binary value representing the x-value, with the controller, to define a cleared x-value;
calculating the arctangent of the quotient of the cleared x-value divided by the cleared y-value, with the controller, to define a calculated arctangent output value, when the cleared x-value is equal to or less than the cleared y-value;
swapping the cleared x-value for the cleared y-value, with the controller, to define a swapped x-value, and swapping the cleared y-value for the cleared x-value, with the controller, to define a swapped y-value, when the cleared x-value is greater than the cleared y-value;
coding a swap bit of the index, with the controller, to indicate that the cleared x-value and the cleared y-value were swapped to define the swapped x-value and the swapped y-value respectively;
calculating the arctangent of the quotient of the swapped x-value divided by the swapped y-value, with the controller, to define a calculated arctangent output value, when the cleared x-value is greater than the cleared y-value;
looking up a segment base angle from an angle adjustment table, with the controller, based on the coded x-bit, the coded y-bit, and the coded swap bit of the index;
extracting a numerical sign from a reverse bit coded into the extracted segment base angle, with the controller;
applying the numerical sign of the reverse bit from the segment base angle to the calculated arctangent output value, with the controller, to define a corrected arctangent value;
clearing the reverse bit of the segment base angle, with the controller, to define a cleared segment base angle; and
adding the corrected arctangent value to the cleared segment base angle, with the controller, to define the arctangent of the point.

2. The method set forth in claim 1 further comprising establishing the index in a memory of the controller.

3. The method set forth in claim 1 wherein clearing the sign bit of the binary value representing the y-value is further defined as clearing the sign bit of the binary value representing the y-value using integer operations of a processor of the controller, and wherein clearing the sign bit of the binary value representing the x-value to define the cleared x-value is further defined as clearing the sign bit of the binary value representing the x-value using integer operations of the processor of the controller.

4. The method set forth in claim 3 further comprising comparing the cleared x-value to the cleared y-value using integer operations of the processor of the controller to determine if the cleared x-value is greater than the cleared y-value.

5. The method set forth in claim 3 further comprising returning a value equal to zero when the cleared y-value is equal to zero.

6. The method set forth in claim 1 wherein the reverse bit of the segment base angle is encoded into one of bit 12 or bit 13 of a 32-bit floating point number representing the segment base angle.

7. The method set forth in claim 1 wherein the angle adjustment table is the only look-up table referenced to calculate the arctangent of the point.

8. The method as set forth in claim 1 wherein the index is a 3-bit binary value.

9. The method as set forth in claim 8 wherein the x-bit, the y-bit, and the swap bit are pre-shifted for use as a table look-up index for a table containing 32-bit data.

10. The method as set forth in claim 11 wherein the x-bit, the y-bit, and the swap bit are coded into a second bit, a third bit, and a fourth bit of the index, respectively.

11. A method of calculating an arctangent for a point located on a plane by an x-value and a y-value of a Cartesian coordinate system, the method comprising:
establishing an index in a memory of a controller, wherein the index includes a 3-bit binary value;
coding a y-bit of the index to indicate a sign of the y-value;
coding an x-bit of the index to indicate a sign of the x-value;
clearing a sign bit of a binary value representing the y-value to define a cleared y-value;
clearing a sign bit of a binary value representing the x-value to define a cleared x-value;
comparing the cleared x-value to cleared y-value to determine if the cleared x-value is greater than the cleared y-value, or if cleared x-value is equal to or less than cleared y-value;
returning a calculated arctangent output value equal to zero when the cleared y-value is equal to zero;
calculating the arctangent of the quotient of the cleared x-value divided by the cleared y-value to define a calculated arctangent output value, when the cleared x-value is equal to or less than the cleared y-value;
swapping the cleared x-value for the cleared y-value to define a swapped x-value, and swapping the cleared y-value for the cleared x-value to define a swapped y-value, when the cleared x-value is greater than cleared y-value;
coding a swap bit of the index to indicate that the cleared x-value and the cleared y-value were swapped to define the swapped x-value and the swapped y-value respectively;
calculating the arctangent of the quotient of the swapped x-value divided by the swapped y-value to define a calculated arctangent output value, when the cleared x-value is greater than the cleared y-value;
looking up a segment base angle from an angle adjustment table, based on the coded x-bit, the coded y-bit, and the coded swap bit of the index;
extracting a numerical sign from a reverse bit coded into the segment base angle;
applying the extracted numerical sign from the reverse bit to the calculated arctangent output value to define a corrected arctangent value;
clearing the reverse bit of the extracted segment base angle to define an cleared segment base angle; and
adding the corrected arctangent value to the cleared segment base angle to define the arctangent of the point.

12. The method set forth in claim 11 wherein the reverse bit of the segment base angle is encoded into one of bit 12 or bit 13 of a 32-bit floating point number representing the segment base angle.

13. The method set forth in claim 11 wherein the angle adjustment table is the only look-up table referenced to calculate the arctangent of the point.

14. The method as set forth in claim 11 wherein the x-bit, the y-bit, and the swap bit are pre-shifted for use as a table look-up index for a table containing 32-bit data.

15. The method as set forth in claim 14 wherein the x-bit, the y-bit, and the swap bit are coded into a second bit, a third bit, and a fourth bit of the index, respectively.

16. The method as set forth in claim 11 wherein clearing the sign bit of the binary value representing the y-value is further defined as clearing the sign bit of the binary value representing the y-value using integer operations, and wherein clearing the sign bit of the binary value representing the x-value to define the cleared x-value is further defined as clearing the sign bit of the binary value representing the x-value using integer operations.

17. The method set forth in claim 11 wherein comparing the cleared x-value to cleared y-value is further defined as comparing the cleared x-value to the cleared y-value using integer operations.

18. The method set forth in claim 11 wherein extracting the numerical sign from the reverse bit is further defined as extracting the numerical sign from the reverse bit using integer operations.

19. The method set forth in claim 11 wherein applying the extracted numerical sign from the reverse bit to the calculated arctangent output value is further defined as applying the extracted numerical sign from the reverse bit to the calculated arctangent output value using integer operations.

20. The method set forth in claim 11 wherein clearing the reverse bit of the extracted segment base angle is further defined as clearing the reverse bit of the extracted segment base angle using integer operations.
